(19) United States
(12) Patent Application Publication
(10) Pub. No.: US 2009/0117846 A1
(43) Pub. Date: May 7, 2009

(54) Media distribution kiosk with virtual connector for interfacing with a personal media device

(75) Inventor: Thomas C. Mavrakakis, Palo Alto, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 11/982,820

(22) Filed: Nov. 5, 2007

(51) Int. Cl. H04H 40/00; G08B 21/00

(52) U.S. Cl. 455/3.06; 340/540

(57) ABSTRACT

Systems and methods are provided for a media distribution kiosk employing a virtual connector to enable communication between a media distribution device and media device while limiting wear on their connectors.

### BACKGROUND

This relates to media distribution and, more particularly, to controlling media distribution to personal media devices using a media distribution kiosk.

The proliferation of compact portable personal media devices (e.g., portable MP3 players, portable video players, and media capable cellular telephones) has enabled users to conveniently carry and interact with such compact portable media devices during virtually any type of activity and in virtually any location. The interaction may include accessing multimedia such as video and audio (e.g., voice and music) and sending or receiving communications via the media device. The types of activities could be personal, social, work-related, or recreational. The activities could occur under various conditions, at various times or dates, in various social settings, or in various personal settings.

In recent years, for example, music delivery or distribution over the Internet to media devices has become popular. Due to the advances in efficient file formats, such as MP3 and MPEG4, the size of media files have become small enough to make their download via the Internet practical. Also, technological advances have led to higher-speed Internet connections and lower cost of memory. The combination of these advances make downloading media files, such as for music and videos, manageable and not too time consuming, even to personal media devices.

One popular approach to music distribution is, for example, mp3.com which uses a centralized server for storage of the numerous songs that are available for download. Another popular example of an approach to music distribution is Napster where peer-to-peer sharing has been utilized. With peer-to-peer sharing, the numerous songs reside on the computer systems of the many users, not on a centralized server.

One problem with these media distribution and sharing systems may be that a user must have access to a computer system to access the centralized server or other computers in the distributed sharing system. Accordingly, there is a need for providing a user of a media device with the ability to conveniently access or download media (e.g., songs) without the need to use their own or another's personal computer system, especially while the user may be traveling or away from their own computer system.

Another problem with existing media distribution systems may be that a user's media device (e.g., portable music player) often must be physically connected to a computer system or media distribution system in order to download the media content. The continuous engagement and disengagement of the media device connector may result in excessive wear and failure of the connector. Also, because certain media distribution systems may be located in public places, a connector of the media distribution system may be exposed to tampering by users or excessive exposure to environmental conditions. Accordingly, there is a need to enable the distribution of media content to a media device while limiting the wear on the device's connector and/or while limiting the need for the media device to connect with a possibly damaged connector of a public media distribution system.

One known alternative to a physical connection is a wireless connection. However, there are numerous problems with a wireless connection which may include susceptibility to eavesdropping, hacking, and overloading where excessive numbers of devices attempt to access the same wireless connection. Accordingly, there is a need for minimizing these issues with wireless connections.

### SUMMARY

The invention, in various embodiments, addresses deficiencies in the prior art by providing systems, methods and devices that enable a media distribution system to conveniently distribute media content to a media device via one or more media distribution kiosks that may be located in virtually any geographic location or venue. Each media distribution kiosk may be connected via a data network to a centralized media storage server to enable the efficient distribution of media content from the storage server to the media distribution kiosk and, ultimately, to a user's media device. The storage server may provide new media content for purchase by a user and/or provide remote user access to one or more of the user's existing libraries of media content.

Unlike a conventional mechanical connector, each media distribution kiosk is configured to provide a virtual physical connection to one or more media devices. By establishing a virtual physical connection as opposed to using the media device's actual connector, the wear on the media device's connector is minimized. The virtual physical connection also reduces the likelihood of eavesdropping, hacking, and overloading of a wireless connection between the media distribution kiosk and a media device. The virtual physical connection further eliminates the need for a media device to connect with a possibly damaged, worn, or unreliable connector of a publicly or environmentally exposed media distribution device.

In one aspect, a media distribution device includes a presence sensor that generates a presence indicator when the physical presence of a media device in proximity to the media distribution device is detected. The media distribution device also includes a wireless transceiver that establishes a wireless data connection with the media device. Further, the media distribution device includes a processor that controls access from the media device to the media distribution device via the wireless data connection based, at least in part, on the presence indicator.

In one configuration, the media device is in proximity to the media distribution device when a portion of the media device housing is in contact with the media distribution device. In another configuration, the media device is in proximity to the media distribution device when the presence sensor detects the physical presence of a portion of the media device housing. The presence sensor may include, without limitation, at least one of an optical sensor, pressure sensor, magnetic sensor, electromagentic sensor, inductive sensor, acoustic sensor, RF sensor, weight sensor, proximity sensor, and video sensor.

In one feature, the media distribution device includes a directional antenna or directional emitter/receiver in communication with the wireless transceiver that directs a radio frequency (RF) signal or other wireless signal associated with the wireless data connection in a selected direction. The RF signal strength may be set to a level to limit the range of the RF signal. The level of RF signal strength and selected direction of the antenna may be set to establish a RF region in which the media device is capable of establishing the wireless data connection, while other media devices outside of the RF region are not able to establish a wireless data connection.

In another feature, the processor controls access to the media distribution device based, at least in part, on information provided by a user of the media device. The user information may include at least one of a username and password. In a further feature, the processor controls access to the media distribution device based on at least one of a token, credit card, access card, debit card, loyalty card, and vendor-specific commerce card.

In another configuration, the media distribution device communicates with an authentication server to obtain authorization to allow media device access to the media distribution device. The media distribution device may also communicate with a media storage server to exchange media content.

In another aspect, a media distribution system includes: a media distribution kiosk that distributes media content, a media device that receives a portion of the media content from the media distribution kiosk, a media commerce server that processing commerce information associated with the distribution of the media content, and a media storage server that distributes the media content from a media store to the media distribution kiosk. The media distribution kiosk also establishes a virtual physical connection with the media device that enables the distribution of a portion of the media content to the media device. In one configuration, the virtual physical connection is established by the media distribution kiosk i) determining the physical presence of the media device in proximity to the media distribution kiosk and ii) establishing a wireless data channel with the media device.

A further aspect includes a method for selectively establishing a wireless data connection that includes: determining the physical presence of a first media device in proximity to a media distribution device, establishing an access region via a directional wireless transceiver associated with the media distribution device, establishing a wireless data connection with the first media device while in the access region, and controlling access from the first media device to the media distribution device via the wireless data connection.

In yet another aspect, a media device includes a presence sensor that generating a presence indicator when the physical presence of a second media device in proximity to the media distribution device is detected. The media device also includes a wireless transceiver that establishes a wireless data connection with the second media device. Further, the media device includes a processor that controls access by the second media device via the wireless data connection based, at least in part, on the presence indicator.

Various advantages and applications of establishing a data connection between elements of a media distribution system in accordance with principles of the present invention are discussed in more detail below.

### BRIEF DESCRIPTION OF THE DRAWINGS

The above and other features of the present invention, its nature and various advantages will become more apparent upon consideration of the following detailed description, taken in conjunction with the accompanying drawings, in which like reference characters refer to like parts throughout, and in which:

FIG. 1 is a block diagram of a media distribution system according to an illustrative embodiment of the invention;

FIG. 2 shows an exemplary media distribution kiosk according to an illustrative embodiment of the invention;

FIG. 3 is a block diagram of a kiosk employing a directed and limited radio frequency zone for interaction with a particular media device according to an illustrative embodiment of the invention;

FIG. 4 is a perspective view of a media device docking station of a media distribution kiosk according to an illustrative embodiment of the invention;

FIG. 5 is a perspective view of a personal media device according to an illustrative embodiment of the invention;

FIG. 6 is a view of another personal media device according to an illustrative embodiment of the invention;

FIG. 7 is a perspective transparent view of the base of a media device including a female connector according to an illustrative embodiment of the invention;

FIG. 8 shows a simplified functional block diagram of a computer system for a media device or media distribution kiosk according to an illustrative embodiment of the invention; and

FIG. 9 includes a flow diagram of an exemplary process for establishing a data connection between a media device and media distribution kiosk according to an illustrative embodiment of the invention.

### DETAILED DESCRIPTION OF THE DISCLOSURE

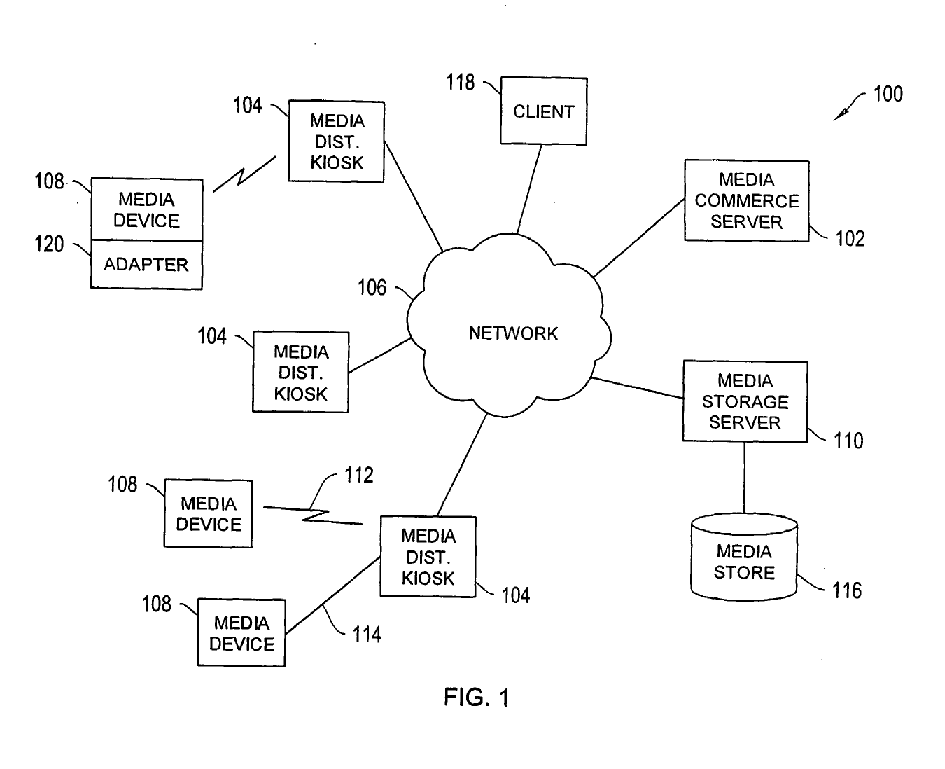

FIG. 1 is a block diagram of a media distribution system 100 according to an illustrative embodiment of the invention. The media distribution and/or purchase system 100 includes a media commerce server 102. In one embodiment, the media commerce server 102 coordinates the review and/or purchase of media content through on-line transactions. On-line transactions to purchase media items may also be referred to as electronic commerce (e-commerce). The media purchase system 100 may also include one or more media distribution kiosks 104. Each media distribution kiosk (MDK) 104 may interface with one or more personal media devices 108. Each media device 108 may include a processor for running one or more media application programs (e.g., software applications). Each MDK 104 may be coupled to the media commerce server 102 via a data network 106. Hence, any of the MDKs 104 can interact with the media commerce server 102 to enable a user to review and/or purchase media content and/or items. In one embodiment, the data network 106 includes at least a portion of the Internet, Public switched telephone network (PSTN), a private network, mobile network, cellular network, mobile data network, satellite network, and/or any like communications network.

In one embodiment, each MDK 104 functions as an intermediate server to enable the distribution of media content, items, and/or files (e.g., mp3 files, video files, audio files, and other like media content) to one or more media devices 108. In certain embodiments, each MDK 104 includes a processor and memory to enable each MDK 104 to interface with and provide media distribution services to one or more media devices 108. An MDK 104 may communicate with and/or exchange data with a media device 108 via a wireless interface 112. An MDK 104 may communicate with and/or exchange data with a media device 108 via a wired and/or physical connection-based interface 114. The capabilities and features of certain types of personal media devices 108 are described in further detail later herein.

In one embodiment, the media distribution system 100 includes a media storage server 110 and a media store 116. In certain embodiments, the media storage server 110 operates as a remote storage server for the one or more MDKs 104 while being in electronic communications with the MDKs 104 via the data network 106. In one embodiment, the media store 112 provides mass data storage of media content and/or media files that are available for distribution and/or purchase via the media distribution system 100. In one embodiment, the media commerce server includes an on-line media content store that is accessible via a MDK 104, but may also be accessible via any client 118 that is connected to the network 106. One example of a media content storage and distribution system includes the Apple iTunes® on-line media store, provided via the Internet by Apple, Inc.

In certain embodiments, the media distribution system 100 allows a user of a media device 108 to use a graphic user interface (GUI) or other interface of an MDK 104 to access, review, purchase, synchronize, download to, upload from, and exchange media content and/or other information between the user's media device 108 and an MDK 104. In another embodiment, an MDK 104 functions as a media access point, gateway, and/or intermediate server whereby a user may utilize the GUI of their media device 108 to interface with the media storage server 110 or another remote media content server via the MDK 104 to enable the distribution of media content to or from the media device 108.

In one embodiment, a media device 108 user utilizes a browser application of the MDK 104 to browse, search or sort through a plurality of media items that can be purchased from the media commerce server 102 and downloaded from the media storage server 110. The MDK 104 may also allow the user to preview media content such as, without limitation, media clips, video clips, movies, songs, pictures, ringtones, audio files, podcasts, electronic books, and the like. In the event that the user of the media device 108 desires to purchase a particular media item, the user (via the MDK 104 and/or media device 108) and the media commerce server 102 may engage in an on-line commerce transaction in which the user pays for access rights to a particular media item (e.g., a song, video, movie, music video, and like media content).

In one embodiment, each MDK 104 may include an application and/or interface for inputting and processing credit cards, loyalty cards, debit card, vendor-specific commerce cards, and for processing other credit and/or financial transactions. Thus, a user may, for example, effect a purchase of a media item using a credit card associated with the user that is credited for the purchase amount of the particular media item. In another embodiment, the media commerce server 102 or an authentication server may include account information associated with one or more users. The account information may include a user identifier, a media device identifier, a user password and/or passcode, a media device secret key and/or authenticator. The media commerce server 102 may include credit card information associated with a particular user or have the capability to access credit information about a particular user. Thus, in certain embodiments, the media commerce server 102 may authorize a media device 108 user to access media content, purchase media content, and/or distribute media content. Other types of electronic payment and/or authorization may be employed such as, without limitation, PayPal, Neteller, micro-payments, and/or pre-paid ATM. Other types of user and/or device authentication may be employed which may include cryptographic authentication using Public-key and/or Private-key cryptography.

In one embodiment, the media device 108 user may be required to enter their user identifier and their associated private password at the GUI of the MDK 104. The user identifier and password may then be sent from the MDK 104 to the media commerce server 102 to allow the media commerce server 102 to verify that the user-entered user identifier and password match the server 102 user identifier and password. Once verified, the media commerce server 102 may then authorize the media device 108 user to access media content via the MDK 104 and/or via media device 108 through a data connection with the MDK 104. Other forms a user and/or device authentication may be employed to authenticate and/or authorized user access to media content.

In certain embodiments, media items are stored in the media store 112 and retrieved via the media storage server 110. Hence, the media commerce server 102 need not burden its resources to deliver any media items to an MDK 104 and, ultimately, to an media device 108 that is linked to a particular MDK 104. Instead, in certain embodiments, on purchasing a particular media item, the media commerce server 102 sends download information to the MDK 104. The download information may then be used by the MDK 104 to retrieve the media content by interacting with the media storage server 110 through the data network 106. In certain embodiments, the MDK 104 may function as an intermediary and/or intermediate server and, thereby, allow an application client, running on a media device 108, to interact with the media storage sever 110.

In certain embodiments, the media storage server 110 obtains the media content from the media store 112 and downloads such content through the data network 106 to a client application running on, for example, a media device 108 via a link 112 and/or 114 with an MDK 104. The downloaded media content may then be accessed by a client media application of the media device 108. In one embodiment, the downloaded media content is stored on the media device 108 as received. In another embodiment, the downloaded media content is decrypted using a first cryptographic key and re-encrypted using a second cryptographic key before being stored in a memory (e.g., hard drive) of a media device 108. Further details regarding various encryption and media purchase techniques are described in further detail in U.S. patent application Ser. Nos. 10/833,267 and 10/832,812, both filed on Apr. 26, 2004, the entire contents of which are incorporated herein by reference.

In a certain embodiments, the media distribution system 100 may use at least one of a number of secure media distribution mechanism or standards. The media distribution system 100 may employ a public and/or proprietary digital rights management (DRM) system or technology. The DRM technology may include, without limitation, at least one of the Digital Transmission Content Protection (DTCP) standard, the Advanced Access Content System (AACS), Content Scrambling System (CSS), DeCSS, Windows DRM (WDRM), Protected Media Path, Protected Video Path (PVP), Blu-ray, OZAuthors, and any like DRM mechanism.

Once media content is downloaded, the media device 108 may present (e.g., play) the media content via one or more media applications. The data connection or connections through the data network 106 between the media commerce server 102, a MDK 104, a media device 108, and the media storage server 110 may include other secure connection links and/or data tunnels, such as Secure Sockets Layer (SSL), a virtual private network (VPN), symmetric encryption links, and/or asymmetric encryption links. Further, the media content may be stored at the MDK 104 and/or a media device 104 in an encrypted manner. These secure data connection links may be employed in addition to or as an added layer of protection for one or more DRM techniques.

In one embodiment, the media distribution system 100 advantageously enables the distribution of media content to a media device 108 via a MDK 104 residing in virtually any location such as an airport, hotel, stadium, train station, shopping mall, stores, planes, ships, public transportation vehicles, and the like. Even a wireless media device 108 may have limited or no access to a particular wireless service provider's data network in certain geographic areas or locations. Thus, a MDK 108 may enable the media device 108 to access the media distribution system 100 even where a wireless service provider's network is not available.

In certain embodiments, each of the MDKs 104 may be linked wirelessly in a daisy-chain and/or serial manner to enable connections with the data network 106. In one embodiment, each MDK 104 includes at least a portion of the media content and/or other data stored by the media store 116. Thus, a MDK 104 may function as a mirror site for the media storage server 110. By functioning as a media mirror site, a MDK 104 may advantageously reduce the latency of accessing or downloading data from the media store 116 by a media device 108 that is linked to the MDK 104 because the media content can be download directly from the MDK 104. In other embodiments, portions of the data of media store 116 are distributed among a plurality of MDKs 104 to provide more efficient media content distribution, redundancy, and disaster recovery for the media store 116. Thus, in a situation where the media storage server 110 fails or becomes inaccessible, a first MDK 104 may access a second MDK 104, acting as a mirror site, to obtain the requested media content and/or other data.

In certain embodiments, an MDK 104 may include metadata associated with various media content. The metadata may, for example, enable a MDK 104 to present information about media content stored both locally and remotely from the MDK 104. In one instance, the MDK 104 may present information associated with media content stored by at least one of the media store 116, a client 118, another MDK 104, a media device 108, and another media content source in communications with the network 106. Thus, in certain embodiments, a MDK 104 is able to present information regarding a relatively large amount of media content while actually only storing of portion of that media content locally within its own local data storage. Further details regarding the use of metadata to enable an MDK 104 to provide a user with access to a distributed library of media content is provided in U.S. patent application Ser. No. 11/701,823, filed on Feb. 2, 2007, having Apple Docket No. P4603US1, entitled “Remote Access of Media Items,” the entire contents of which are incorporated herein by reference.

In certain embodiments, an MDK 104 employs a statistical model, policy, usage history, usage algorithm and/or mechanism to determine which media content items and/or types of media content are stored locally, while other media content, being referenced by metadata, is stored remotely at, for example, the media store 116. In one exemplary approach, an MDK 104 may maintain a history of the types of media content that users have accessed and/or downloaded over a period of time. If a majority of users have downloaded R&B music over a period of time, e.g., certain R&B music is relatively popular, the MDK 104 may download a library of R&B media content from the media store 116 so that R&B music content can be more efficiently downloaded from a memory of the MDK 104 to a media device 108. The types of media content may depend on other factors such as, without limitation, a geographic location, a venue, a type of store in which the MDK 104 is located, and demographics of users within the vicinity of the MDK 104.

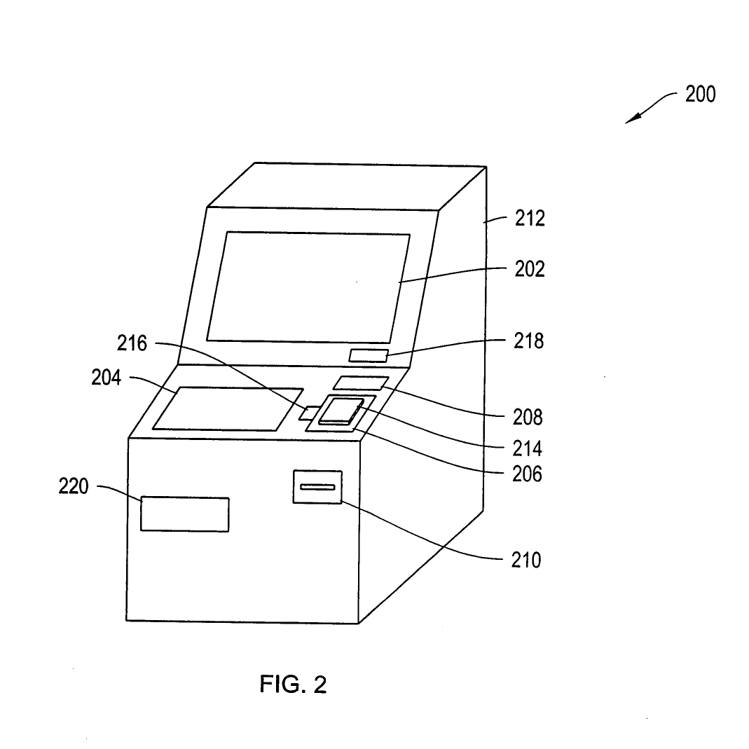

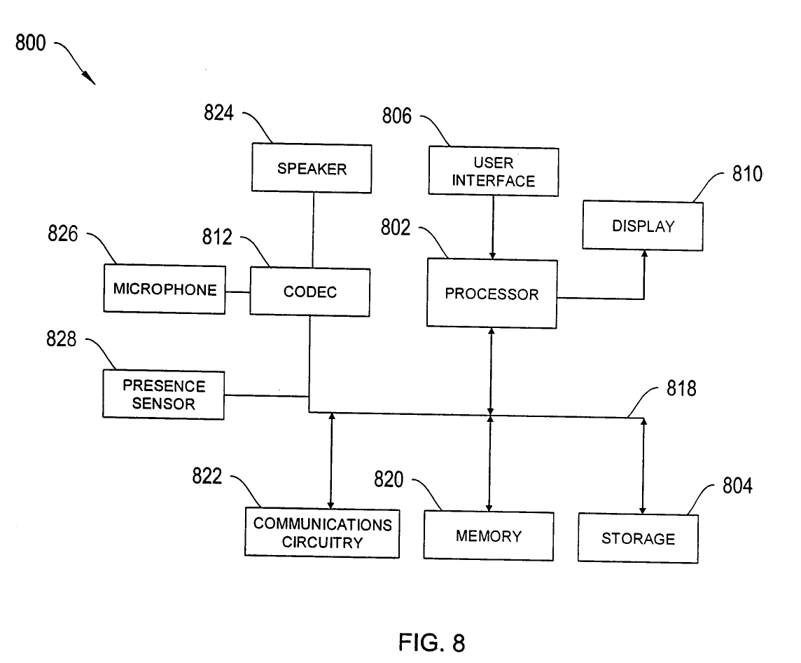

FIG. 2 shows an exemplary media distribution kiosk (MDK) 200 according to an illustrative embodiment of the invention. The MDK 200 may include a display 202, a keypad 204, an access pad 206, a media device docking station 208, a credit/data card receptacle 210, a housing 212, a media device presence sensor 216, a wireless antenna 218, and a media dispenser 220. The dispenser 220 may enable the dispensing of media content on certain media articles such as a CD-ROM, DVD, Blu-ray disk, data card, portable drive, and the like. In certain embodiments, the MDK 200 includes a computer system and other electronic elements as described in more detail with respect to FIG. 8. The MDK 206 of FIG. 2 includes an exemplary form factor similar in shape and size to a stand-alone Automatic Teller Machine (ATM). However, other form factors and configurations may be employed. For example, the MDK 200 may include a personal computer with an accessory docking station. The MDK 200 may include a panel or wall-mounted ATM form factor. The MDK 200 may simply include a wireless interface for a media device. The MDK 200 assume any number of configurations and/or forms. In certain embodiments, the MDK 200 employs an web browser and/or other application that interfaces with the media commerce server 102, media storage server 110, a user specific server, a remote client 118, an authentication server, and/or any other remote system via the data network 106.

In one embodiment, the display 202 may include a GUI that supports a web browser and/or other media distribution application. The keypad 204 may include a pointer component or mouse to enable navigation within the web browser and/or media distribution application. In another embodiment, the display 202 includes a touch screen to enable a user to navigate through a media distribution application.

The MDK 200 may include a wireless interface capable of communicating with a media device 214 via a wireless antenna 218 and wireless interface. The MDK 200 may support one or more wireless interface technologies. The MDK 200 may support, without limitation, 802.1x, Wi-Fi, Bluetooth, CDMA, CDPD, TDMA, GSM, EV-DO, EV-DV, GSM Edge, 3GSM, and other public or proprietary wireless and/or mobile interfaces. The MDK 200 may also support an infrared, acoustic, inductive, and/or light-based interface with a media device 214. Accordingly, a media device 214 may communicate with the MDK 200 via an infrared link or a inductively-coupled link to facilitate the exchange of data including media content. Thus, the term “antenna” includes an RF antenna for propagating RF signals and other types of emitter/receiver elements that are used for propagating other types of wireless signals.

One problem with employing an wireless access point for media devices is that many devices within the vicinity of the MDK 200 may attempt to access the MDK 200 which could overload the wireless interface. Also, an eavesdropper may attempt to intercept communications between the MDK 200 and a media device 214, and possibly acquire media content, media device, and user personal information.

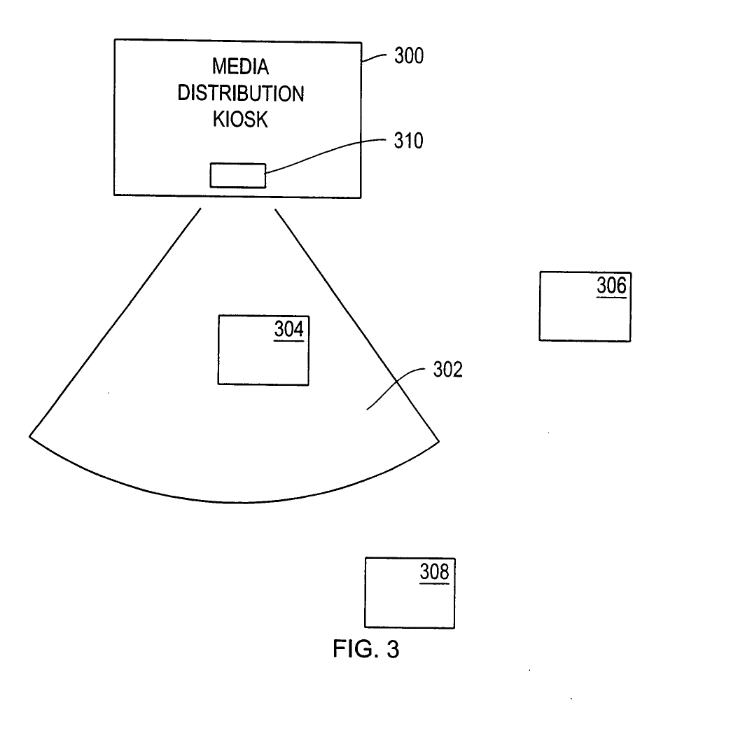

FIG. 3 is a block diagram of a media distribution kiosk (MDK) 300 employing a directed and limited radio frequency zone 302 for interaction with a particular media device 304 according to an illustrative embodiment of the invention. In one embodiment, the MDK 300 advantageously addresses the overloading and eavesdropping problems by employing a directional antenna 310 and/or 218 that provides a limited RF region 302 in which a media device 304 can exchange data with the MDK 300. In another embodiment, the power output and/or signal strength from the antenna 310 and/or 218 is limited to further limit the size of the RF region 302 in which a wireless device can interact with the MDK 300. Thus, while the media device 304 is able to communicate with the MDK 300, the media devices 306 and 308, being outside of the RF region 302, are unable to receive sufficient signal strength to acquire and/or interface with the MDK 300.

Returning to FIG. 2, the MDK 200 may include an access pad 206 that receives a media device 214. The access pad 206 may include a surface upon which the media device 214 is placed. In one embodiment, the access pad 206 is enclosed, at least partially, by a RF-shielded cover to limit the RF emissions from the antenna 218 to only a media device positioned on the access pad 206. In another embodiment, the MDK 200 includes a media device presence sensor 216. In one embodiment, the presence sensor 216 senses when the media device 214 is positioned on and/or within the vicinity of the access pad 206. The presence sensor may also determine the position and/or orientation of the media device 214. In one embodiment, the presence sensor 216 generates a presence indicator only when the media device 214 is properly positioned in relation to the MDK 200. The presence sensor may include a electromagnetic sensor, RF sensor, weight sensor, pressure sensor, magnetic sensor, inductive sensor, optical sensor, sonic sensor, video sensor, acoustic sensor, or other like proximity sensor. For example, the presence sensor may include an optical sensor that sense when a media device 214 is placed on the access pad 206. In one embodiment, the presence sensor 216 includes a directional RF receiver for receiving a data signal from a media device 108 only when the media device 108 is positioned within the directional field of the RF receiver. The RF receiver may be directed toward an enclosed space, semi-enclosed space and/or a confined location such that detection of a particular RF and/or wireless signal indicates the physical presence of a media device 108 with regard to the MDK 200. In one embodiment, a presence sensor may be integrated with a wireless transceiver in communications with the directional antenna 218.

The MDK 200 may also include a docking station 208 having a physical connector to enable a media device 214 to physically connect to a mechanical data port of the MDK 200. In one embodiment, the physical connector supports at least one of a USB and Firewire data interface. One problem with using a docking station 208 with a physical connector is that the MDK 200 connector and/or the mating media device 214 connector may wear, become damaged, or fail mechanically due to continuous physical engagement and disengagement of the connectors between the MDK 200 and a media device 214. However, in certain embodiments, the MDK 200 avoids physical wear of the media device 214 and MDK 200 connector by advantageously employing a virtual physical connection.

In one embodiment, by employing a presence sensor 216 in conjunction with a wireless interface via the antenna 218 or another wireless data port (e.g., infrared), the MDK 200 confirms the physical presence of the media device 218 and establishes a data connection wirelessly without the need to physically connect to the media device 218. Accordingly, the MDK 200 may employ a virtual connector by sensing the physical presence of a media device 214 and establishing a wireless data connection with the media device 214. In other words, in one embodiment, a virtual physical connection is established by sensing the media device's physical presence and establishing a wireless data connection. However, to enable backwards compatibility with versions of media devices that do not have a wireless interface, the MDK 200 may include a media device docking station 208 having a physical connector that is mounted on or embedded within a portion of the MDK 200 housing 212.

Referring to FIG. 1, in another embodiment, a media device 108 may be detachably connectable to a wireless adapter unit 120. The wireless adapter unit 120 may include a wireless transceiver to facility wireless communications with other wireless enabled devices, such as an MDK 104. Thus, the wireless adapter unit 120, in one embodiment, enables a media device 108 to establish a virtual physical connection with an MDK 104.

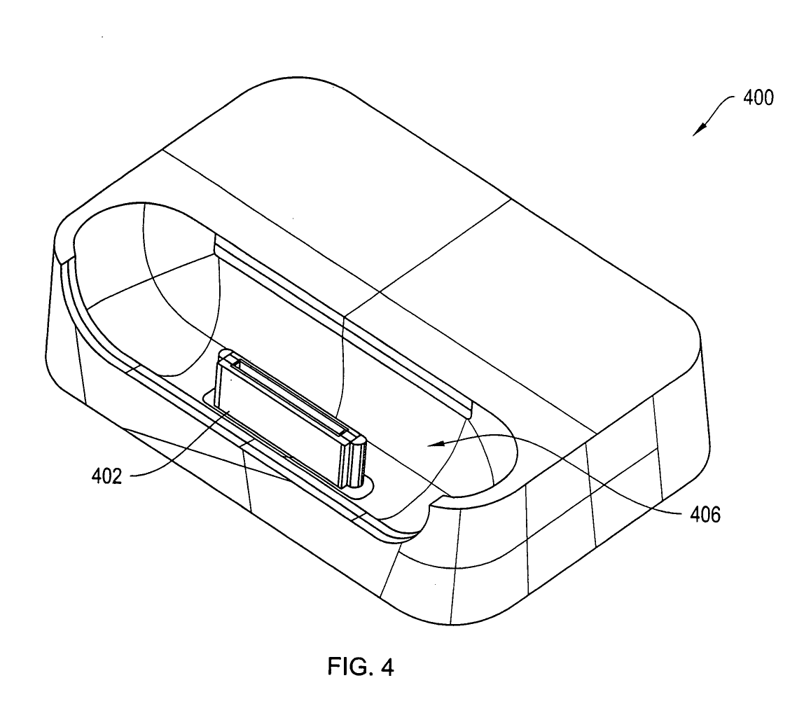

FIG. 4 is a perspective view of a media device docking station 400 of a media distribution kiosk (MDK), such as MDK 200 of FIG. 2, according to an illustrative embodiment of the invention. The docking station 400 may include a connector 402. The connector 402 may be positioned within a well 406 of the docking station 400 to enable convenient mounting and support of a media device while the media device's connector is engaged with the male connector 402 of the docking station 400. The docking station 400 should be considered exemplary in that the docking station 400 may include numerous form factors or configurations. For example, the docking station 400 may have an opening that is level with the MDK 200 housing 212. The docking station may only include a connector 402 extending away from the MDK 200 housing 212. In one embodiment, the docking station 400 may include an elongated well 406 or slot to provide more precise alignment and a more secure engagement with a media device.

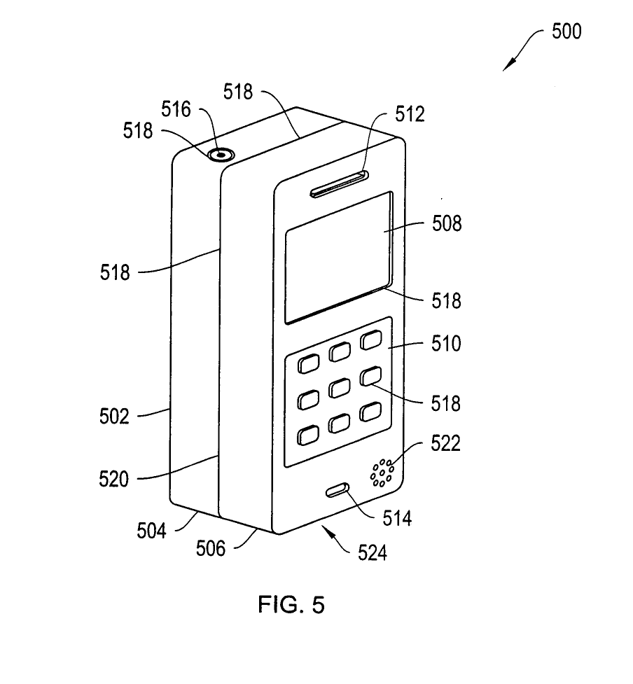

FIG. 5 is a perspective view of a media device 500 according to an illustrative embodiment of the invention. The media device 500 includes a housing 502, a first housing portion 504, a second housing portion 506, a display 508, a keypad 510, a speaker housing aperture 512, a microphone aperture 514, and a headphone jack 516. The housing 502 also includes various gaps 518 that may include openings, separations, vents, or other pathways between elements of the housing 502 that enable the passage of air, sound, or light through the housing 502. The speaker housing aperture 512 may be located in proximity to a lower portion of the media device 500 and/or a second speaker aperture or apertures 522 may be located in a lower portion of the media device associated with, for example, an internal hands-free speaker. In certain embodiments, the microphone aperture 514 and/or speaker apertures 522 may be located on a bottom side 524 of the media device 500. The aperture 514 and apertures 522 may be located on any portion of the housing 502 to facilitate the delivery and reception of sound.

In one embodiment, the housing 502 includes a first housing portion 504 and a second housing portion 506 that are fastened together to encase various components of the media device 500. The housing 502 and its housing portions 504 and 506 may include polymer-based materials that are formed by, for example, injection molding to define the form factor of the media device 500. In one embodiment, the housing 502 surrounds and/or supports internal components such as, for example, one or more circuit boards having integrated circuit components, internal radio frequency (RF) circuitry, an internal antenna, a speaker, a microphone, a hard drive, a processor, and other components. Further details regarding certain internal components are discussed later with respect to FIG. 8. In one embodiment, the housing 502 provides for mounting of a display 508, keypad 510, external jack 516, data connectors, or other external interface elements.

The media device 500 may include a wireless communications device such as a cellular telephone, satellite telephone, cordless telephone, personal digital assistant (PDA), pager, portable computer, or any other device capable of wireless communications. In fact, FIG. 5 shows an exemplary cellular telephone version of a broad category of media device 500.

The media device 500 may also be integrated within the packaging of other devices or structures such a vehicle, video game system, appliance, clothing, helmet, glasses, wearable apparel, stereo system, entertainment system, or other portable devices. In certain embodiments, the media device 500 may be docked or connected to a wireless enabling accessory system (e.g., a wi-fi docking system) that provides the media device 500 with short-range communicating functionality. Alternative types of media devices 500 may include, for example, a media player such as an iPod® or Apple® iphone available by Apple Inc., of Cupertino, Calif., pocket-sized personal computers such as an iPAQ® Pocket PC available by Hewlett Packard Inc., of Palo Alto, Calif. and any other device capable of communicating wirelessly (with or without the aid of a wireless enabling accessory system).

In certain embodiments, the media device 500 may synchronize with, for example, a remote computing system or server, such as media storage server 110, to receive media (using either wireless or wireline communications paths). Wireless syncing enables the media device 500 to transmit and receive media and data without requiring a wired connection. Media may include, without limitation, sound or audio files, music, video, multi-media, and digital data, in streaming and/or discrete (e.g., files and packets) formats.

During synchronization, a host system, e.g., media storage server 110 or MDK 200, may provide media to a client system or software application embedded within the media device 500. In certain embodiments, media and/or data is “downloaded” to the media device 500. In other embodiments, the media device 500 is capable of uploading media to a remote host or other client system. Further details regarding the capabilities of certain embodiments of the media device 500 are provided in U.S. patent application Ser. No. 10/423,490, filed on Apr. 25, 2003; U.S. application Ser. No. 11/770,641, filed Jun. 28, 2007; and U.S. application Ser. No. 11/834,604, filed Aug. 6, 2007, entitled “Synching Data” (Apple Docket No. P5436US1), the entire contents of each of which are incorporated herein by reference.

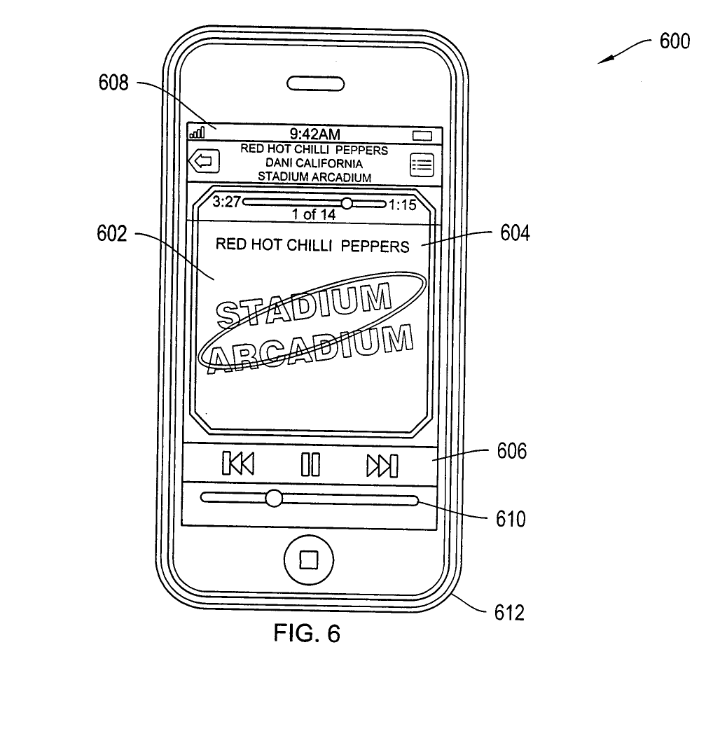

FIG. 6 is a view of another personal media device 600 according to an illustrative embodiment of the invention. The media device 600 includes a display 602 showing a status bar 608 and video image 604, which may include, for example, a music video, a movie, video clip, or like video images. In one embodiment, a GUI of the display 602 includes an interface 606 that enables the media device 600 user to play, pause, fast forward, reverse, or monitor, via a slider 610, the progress of the video displayed on the display 602. The media device 600 includes a housing base 612.

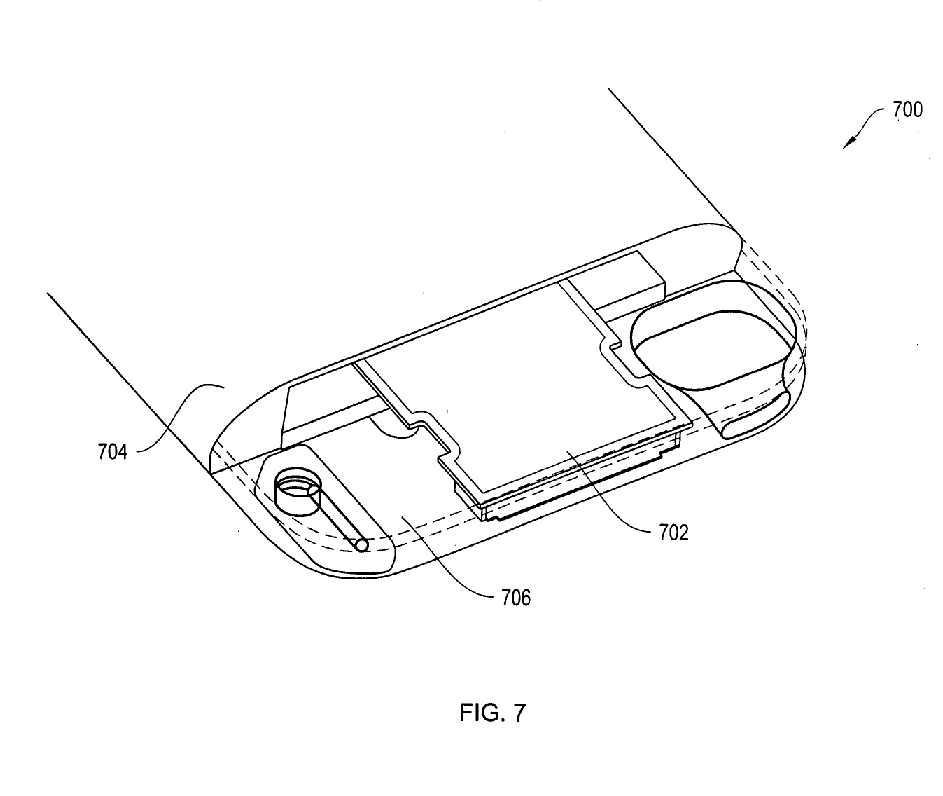

FIG. 7 is a perspective transparent view of the base 706 of a media device 700 including a female connector 702 according to an illustrative embodiment of the invention. The media device 700 also includes a housing 704. In one embodiment, the female connector 702 is capable of detachably engaging and/or connecting with the male connector 402 of FIG. 4.

FIG. 8 shows a simplified functional block diagram of computing environment 800 of, for example, the media device 500 or the media distribution kiosk 200 according to an illustrative embodiment of the invention. The media device or player 500, or media distribution kiosk 200, may include a processor 802, storage device 804, user interface 808, display 810, CODEC 812, bus 818, memory 820, communications circuitry 822, a speaker or transducer 824, a microphone 826, and/or a presence sensor 828. Processor 802 may control the operation of many functions and other circuitry included in media device 500 and/or MDK 200. The processor 802 may drive display 810 and may receive user inputs from the user interface 808. The presence sensor 828 may include a an optical sensor, an acoustic sensor, magnetic sensor, inductive sensor, pressure sensor, weight sensor, radio frequency sensor, optical sensor, sonar sensor, proximity sensor, and any other sensor capable of detecting the presence of another device. In certain embodiments, a sensor may include an emitter and receiver. For example, an optical sensor may include an infrared emitter and receiver. When an object such as a media device 500 blocks the reception of the infrared signal at the receiver, the detecting device, e.g., MDK 200, determines that the object is physically present at a particular location, e.g., the access pad 206.

Storage element 804 may store media (e.g., music and video files), software (e.g., for implanting functions on device 800, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish wireless communication with another device), subscription information (e.g., information that keeps tracks of podcasts or television shows or other media a user subscribes to), and any other suitable data. Storage device 804 may include one more storage mediums, including for example, a hard-drive, permanent memory such as ROM, semi-permanent memory such as RAM, flash memory, or cache.

Memory 820 may include one or more different types of memory which may be used for performing device functions. For example, memory 820 may include cache, ROM, flash, and/or RAM. Bus 818 may provide a data transfer path for transferring data to, from, or between at least storage device 804, memory 820, and processor 802. Coder/decoder (CODEC) 812 may be included to convert digital audio signals into an analog signals for driving the speaker 824 to produce sound including voice, music, and other like audio. The CODEC 812 may also convert audio inputs from the microphone 826 into digital audio signals. The CODEC 812 may include a video CODEC for processing digital and/or analog video signals.

User interface 808 may allow a user to interact with the media device 500 or MDK 200. For example, the user input device 808 can take a variety of forms, such as a button, keypad, keyboard, dial, a click wheel, or a touch screen. Communications circuitry 822 may include circuitry such as a wireless transceiver for wireless communication (e.g., short-range and/or long range communication). For example, the wireless communication circuitry may be Wi-Fi enabling circuitry that permits wireless communication according to one of the 802.1x standards. Other wireless network protocols standards could also be used, either in alternative to the identified protocols or in addition to the identified protocol. Other network standards may include Bluetooth, the Global System for Mobile Communications (GSM), and code division multiple access (CDMA) based wireless protocols. Communications circuitry 822 may also include circuitry that enables the media device 500 or MDK 200 to be electrically coupled to another device (e.g., a computer or an accessory device) and communicate with that other device. In certain embodiments, the wireless communications may include infrared, inductive, magnetic, electromagnetic, spread spectrum, and like wireless mechanisms. Thus, a wireless transceiver, in certain embodiments, includes a infrared transceiver, inductive transceiver, magnetic transceiver, and the like.

In one embodiment, the computing environment 800 is included in a portable computing device dedicated to processing media such as audio and video. For example, the environment 800 may be included in a media device 500 that includes a media player (e.g., MP3 player), a game player, a remote controller, a portable communication device, a remote ordering interface, an audio tour player, or other suitable personal device. The media device 500 may be battery-operated and highly portable so as to allow a user to listen to music, play games or video, record video or take pictures, communicate with others, and/or control other devices. In addition, the media device 500 may be sized such that it fits relatively easily into a pocket or hand of the user. By being handheld, the media device 500 (or media device 600 shown in FIG. 6) is relatively small and easily handled and utilized by its user and thus may be taken practically anywhere the user travels.

In another embodiment, the computing environment 800 is included in a computer server operating as, for example, an MDK 200. In such an embodiment, the storage 804 may include a relatively large data storage capacity as compared with the storage capacity for a media device 500. Also, for example, the processor 802 may have greater processing power and speed relative to a portable computing device such as the media device 500.

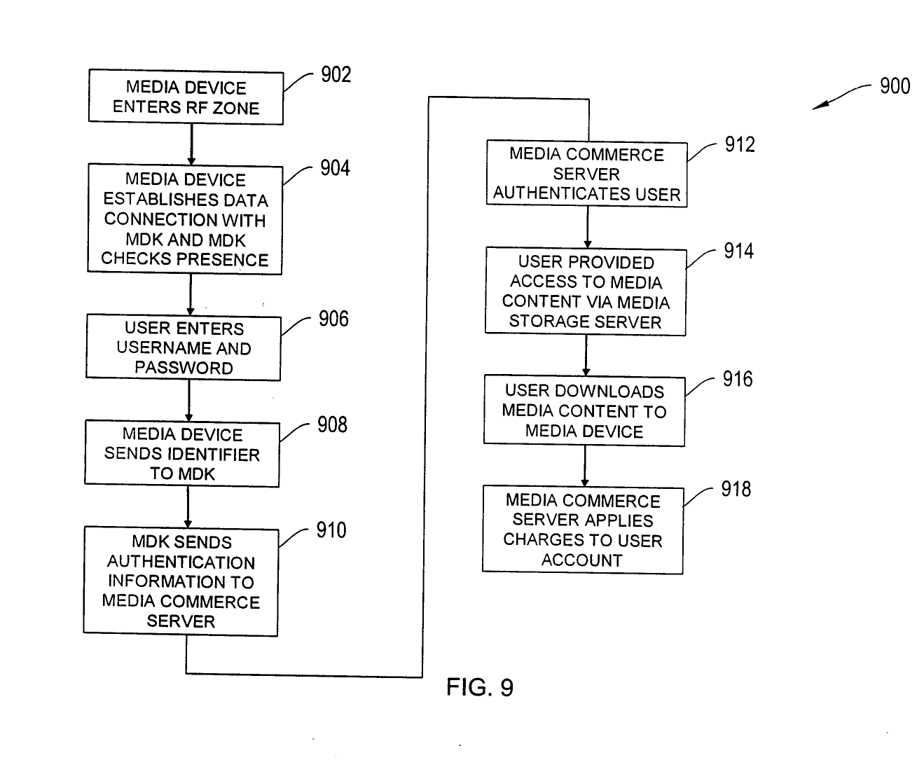

FIG. 9 includes a flow diagram 900 of an exemplary process for establishing a data connection between a media device 500 and media distribution kiosk 200 according to an illustrative embodiment of the invention. Initially, a media device 500 enters an RF zone or region 302 of a MDK 200 (Step 902). In certain embodiments, the region 302 may be referred to as an access region 302 when, for example, a wireless transceiver utilized infrared signals or other non-RF signals. In one instance the media device user may place their media device 214 on an access pad 206 of the MDK 200. Once within the RF region 302, the MDK 200 and media device 214 establish a wireless data connection, e.g., connection 112. The protocol and/or interface used to establish the data connection may vary depending on the capabilities of the MDK 200 and the media device 214. The MDK also senses the physical presence of the media device 214 using a presence sensor 216. By sensing the physical presence of the media device 214 and establishing a wireless data connection, the MDK 200 and media device 214 establish a virtual physical connection (Step 904).

In one embodiment, a media device user may be prompted via the display 202 to enter a username and password into an access application of the MDK 200 (Step 906). Alternatively, the user may be prompted to insert a credit card, loyalty card, service/vendor-specific commerce card, and/or token into the receptacle 210 to enable the MDK 200 and/or media commerce server 102 to authenticate the media device user's access to the media storage server 110. A token, card, or any other like authorization article may include identity information such as, without limitation, a user name, address, and one or more passwords and/or secret keys. A token, card, or any other like authorization article may include personal financial information, credit information, purchase information, media information, media metadata, and any other information associated with a user. As another alternative, the media device 214 may send its device identifier to the MDK 200 via the wireless connection (Step 908). The MDK 200 may then forward the identifier to the media commerce server 102 or another server to obtain user account information associated with the media device 214 identifier.

Based on the media device 214 identifier and the username information provided by the user, the MDK 200 may confirm that the wireless data connection is with the proper media device 214. Once the requested user information and/or media device information is received, the MDK 200 may then forward this information to the media commerce server 102 or another authentication server (Step 910). The media commerce server 102 or an authentication server may then authenticate that the user information (e.g., username and password) and/or media device information is consistent with its own account information (Step 912).

Once the user is authenticated, the media commerce server 102 allows the user to access the media content via the media storage server 110 (Step 914). The media device 214 user may then enable the download of media content from the media storage server 110 to the MDK 200 and/or to the media device 214 via the MDK 200 (Step 916). Once the transaction is complete, the media commerce server 102 may then apply the appropriate charges to the user's account and/or credit source associated with access to the media content.

In certain instances, a media device user may desire to only sync their media device with an existing personal data store of media content. In other instances, a media device user may desire to purchase media content via the MDK 200 for their personal media device. In another instance, a personal media device user may desire to purchase or download media content to a media article such as a CD-ROM. In yet another instance, a media device user may desire to purchase access to certain media content, e.g., a movie, for a limited period of time. The media distribution system 100 at least supports any one of the foregoing instances of media distribution.

A media device 214 may include a presence trigger for indicating the physical presence of the media device 214 in proximity to a media distribution device such as an MDK 104. The presence trigger may include an active and/or passive trigger. The presence trigger may include a physical element, structure, and/or component.

For example, a portion of the housing may include a particular metal or alloy that is detectable by the presence sensor 216 of an MDK 200. The presence trigger may include a magnet that is embedded within or attached to a portion of a media device 214, while the presence sensor 216 includes a magnetic switch. Thus, when the media device 214 is in proximity to the presence sensor 216, the magnetic field of the magnet may trigger the switch within the presence sensor 216 and, thereby, enable the presence sensor 216 to generate a presence indicator signal.

In another embodiment, the presence trigger may include a RF signal, acoustic signal, light signal, or other emitted signal. For example, an RF signal may include a periodic wireless beacon, intermittent signal, continuous signal, and/or other designated signal that provides any other device within the media device's vicinity with an indication of the media device's presence. Similar variations or types of signal emissions may be employed using acoustic, light, and/or optical signals. The emitted signal strength may be adjusted and/or limited such that only a device within a limited range or distance of the media device 214 may be able to detect the emitted presence trigger signal.

In certain embodiments, the presence trigger may only be activated when the media device 214 is positioned or orientated in a particular manner and/or arrangement in relation to another device such as an MDK 104. For example, an MDK 104 may include a vertical slot such that a media device 214 must be positioned on one side. A media device 214 environmental sensor (e.g., accelerometer) may detect this positioning and, in response, activate a presence trigger of the media device 214, which may then be detected by a presence sensor 216 of an MDK 104.

In other embodiments, the presence trigger may include a data signal, one or more data flags, and/or one or more message indicators within a data message and/or packet that act as a presence trigger to another device, such as an MDK 104. The presence trigger signal, for example, may indicate to a MDK 104 that a data connection should be established with a particular media device 214 or limited set of media devices 214. For instance, a master (e.g., MDK 104) of a Bluetooth piconet may limit the number of slaves (e.g., media devices) with access to the piconet to a single slave (e.g., media device 214) based on a presence trigger signal sent by the media device 214. Similar types of presence trigger signals, flags, and/or indicators may be employed in other wireless protocols such as 802.1x, GSM, CDMA, mobile networks, and other wireless systems.

It will be apparent to those of ordinary skill in the art that methods involved in the present invention may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, or flash memory device having a computer readable program code stored thereon.

It is understood that the various features, elements, or processes of the foregoing figures and description are interchangeable or combinable to realize or practice the invention describe herein. Those skilled in the art will appreciate that the invention can be practiced by other than the described embodiments, which are presented for purposes of illustration rather than of limitation, and the invention is limited only by the claims which follow.

What is claimed is:

1. A media distribution device comprising:
a presence sensor for generating a presence indicator when the physical presence of a media device in proximity to the media distribution device is detected,
a wireless transceiver for establishing a wireless data connection with the media device, and
a processor for controlling access from the media device to the media distribution device via the wireless data connection based, at least in part, on the presence indicator.

2. The device of claim 1, wherein the media device is in proximity when a portion of the media device housing is in contact with the media distribution device.

3. The device of claim 1, wherein the media device is in proximity when the sensor detects the physical presence of a portion of the media device housing.

4. The device of claim 1, wherein the sensor includes at least one of an optical sensor, pressure sensor, magnetic sensor, electromagentic sensor, inductive sensor, acoustic sensor, RF sensor, weight sensor, proximity sensor, switch, and video sensor.

5. The device of claim 1 comprising a directional antenna in communication with the wireless transceiver for directing a RF signal associated with the wireless data connection in a selected direction.

6. The device of claim 5, wherein the RF signal strength is set to a level to limit the range of the RF signal.

7. The device of claim 6, wherein the level of RF signal strength and selected direction of the antenna establish a RF region where the media device is capable of establishing the wireless data connection.

8. The device of claim 1, wherein the processor controls access to the media distribution device based, at least in part, on information provided by a user of the media device.

9. The device of claim 8, wherein the information includes at least one of a username and password.

10. The device of claim 1, wherein the processor controls access to the media distribution device based on at least one of a token, credit card, access card, debit card, loyalty card, and vendor-specific commerce card.

11. The device of claim 1, wherein the media distribution device communicates with an authentication server to obtain authorization to allow media device access.

12. The device of claim 11, wherein the media distribution device communicates with a media storage server to exchange media content.

13. A method for distributing media content comprising:
sensing the physical presence of a media device in proximity to a media distribution device,
generating a presence indicator in response to sensing the physical presence of the media device,
establishing a wireless data connection between the media distribution device and the media device, and
controlling access to the media distribution device via the wireless data connection based, at least in part, on the presence indicator.

14. The method of claim 13, wherein the media device is in proximity when a portion of the media device housing is in contact with the media distribution device.

15. The method of claim 13, wherein the media device is in proximity when the sensor detects the physical presence of a portion of the media device housing.

16. The method of claim 13, wherein the sensor includes at least one of an optical sensor, pressure sensor, magnetic sensor, electromagentic sensor, inductive sensor, acoustic sensor, RF sensor, weight sensor, proximity sensor, a switch, and video sensor.

17. The method of claim 13 comprising directing a RF signal associated with the wireless data connection in a selected direction using a directional antenna in communication with the wireless transceiver.

18. The method of claim 17 comprising setting the RF signal strength to a level that limits the range of the RF signal.

19. The method of claim 18 comprising forming a RF region where the media device is capable of establishing the wireless data connection based the level of RF signal strength and selected direction of the antenna

20. The method of claim 13 comprising controlling access to the media distribution device based, at least in part, on information provided by a user of the media device.

21. The method of claim 20, wherein the information includes at least one of a username and password.

22. A media distribution system comprising:
a media distribution kiosk for distributing media content
a media device for receiving a portion of the media content from the media distribution kiosk,
a media commerce server for processing commerce information associated with distributing the media content, and
a media storage server for distributing the media content from a media store to the media distribution kiosk,
wherein the media distribution kiosk establishes a virtual physical connection with the media device to enable the distribution of a portion of the media content to the media device.

23. The system of claim 24, wherein the virtual physical connection is established by the media distribution kiosk i) determining the physical presence of the media device in proximity to the media distribution kiosk and ii) establishing a wireless data channel with the media device.

24. A method for selectively establishing a wireless data connection comprising:
determining the physical presence of a first media device in proximity to a media distribution device,
establishing an access region via a directional wireless transceiver associated with the media distribution device,
establishing a wireless data connection with the first media device while in the access region, and
controlling access from the first media device to the media distribution device via the wireless data connection.

25. A media device comprising:
a presence trigger for indicating the physical presence of the media device in proximity to a media distribution device, and
a wireless transceiver for establishing a wireless data connection with the media distribution device.
